(19) United States
(12) Patent Application Publication
(10) Pub. No.: US 2016/0203793 A1
(43) Pub. Date: Jul. 14, 2016

(54) ELECTRONIC DEVICE AND METHOD OF OPERATING THE SAME

(71) Applicant: SAMSUNG ELECTRONICS CO., LTD., Suwon-so (KR)

(72) Inventor: Wan-su KIM, Anyang-si (KR)

(73) Assignee: SAMSUNG ELECTRONICS CO., LTD., Suwon-si (KR)

(21) Appl. No.: 14/925,401

(22) Filed: Oct. 28, 2015

(30) Foreign Application Priority Data
Jan. 14, 2015 (KR) 10-2015-0006981

(51) Int. Cl. G09G 5/12; G06F 3/14; G06F 3/0481; G06F 3/0484; G06F 3/0482

(52) U.S. Cl. CPC G09G 5/12; G06F 3/04842; G06F 3/0482; G06F 3/04812; G06F 3/04845; G06F 3/1454

(57) ABSTRACT

An electronic device includes a user input unit configured to receive an input that is indicative of at least one selection from among a plurality of subjects and a plurality of writing backgrounds and receive a writing input, and a display unit. The electronic device includes a controller configured to detect writing content that matches the writing input based on the at least one selection from among the plurality of subjects and the plurality of writing backgrounds and output the detected writing content on a screen of the display unit.

### CROSS-REFERENCE TO RELATED APPLICATIONS

This application claims the benefit of Korean Patent Application No. 10-2015-0006981, filed on Jan. 14, 2015, in the Korean Intellectual Property Office, the disclosure of which is incorporated herein in its entirety by reference.

### BACKGROUND

1. Field

The present disclosure relates to electronic devices and methods of operating the same, and more particularly, to electronic devices capable of providing user convenience and methods of operating the same.

2. Description of the Related Art

Unlike a common blackboard which is only used to write on, an electronic device that may be used as an electronic blackboard may support not only writing but also various other functions. However, the more various the functions that the electronic device supports, the more complicated a menu configuration that provides the functions. Thus, since a user may have difficulties in effectively using the various functions of the electronic device, user convenience and satisfaction with respect to the electronic device deteriorate.

Therefore, an electronic device capable of providing enhanced user convenience and a method of operating the electronic device are required

### SUMMARY

Provided are an electronic device capable of providing user convenience and a method of operating the electronic device.

Additional aspects will be set forth in part in the description which follows and, in part, will be apparent from the description, or may be learned by practice of the presented exemplary embodiments.

According to an aspect of an exemplary embodiment, an electronic device includes a user input unit configured to receive an input that is indicative of at least one selection from among a plurality of subjects and a plurality of writing backgrounds and receive a writing input, a display unit, and a controller configured to detect writing content that matches the writing input based on the at least one selection from among the plurality of subjects and the plurality of writing backgrounds and output the detected writing content on a screen of the display unit.

The controller may determine whether the writing input matches content associated with the selected subject or the selected writing background prior to determining whether the writing input matches content other than that is associated with the selected at least one of the plurality of subjects or the plurality of writing backgrounds.

The electronic device may further include a memory configured to store a plurality of pieces of writing content according to the plurality of subjects and a plurality of pieces of writing content according to the plurality of writing backgrounds.

The controller may output at least one function button associated with the selected at least one of the plurality of subjects and the plurality of writing backgrounds on the screen.

The electronic device may further include a communication unit configured to receive information informing that a fixed color button or a color change button is selected from an input apparatus including the fixed color button and the color change button, wherein the controller outputs color information set in the input apparatus on the screen based on the information.

The electronic device may further include a communication unit configured to communicate with a user device, wherein the controller controls the communication unit to make the screen of the display unit interact with a screen of the user device.

The controller may receive a second writing input from the user device via the communication unit, detect second writing content that matches the second writing input based on the at least one selection of the subject and the writing background, and output the second writing content onto the screen.

The controller may output a pointer visually associated with a pointer that is input to the user device onto the screen of the display unit.

The electronic device may further include a memory configured to store a student list, wherein the user input unit receives an input instructing selection of a speaker, and wherein the controller arbitrarily selects a student as the speaker from the student list and outputs a name of the selected student onto the screen.

According to an aspect of another exemplary embodiment, an input apparatus configured to input writing onto a screen of an electronic device includes a communication unit configured to communicate with the electronic device; a fixed color button configured to set a color of writing content that is output on the screen of the electronic device as a fixed color; a color change button configured to change the color of the writing content to one of a plurality of colors; and a controller configured to control the communication unit to transfer, to the electronic device, information informing that the fixed color button or the color change button is selected.

According to an aspect of another exemplary embodiment, a method of operating an electronic device includes receiving a user input indicative of at least one selection from among a plurality of subjects and a plurality of writing backgrounds; receiving a writing input; detecting writing content that matches the writing input based on the selection from among the plurality of subjects and the plurality of writing backgrounds; and outputting the writing content onto a screen.

It may be firstly determined whether the writing input matches content associated with the at least one selection from among the plurality of subjects and the plurality of writing backgrounds.

The method may further include storing a plurality of pieces of writing content according to the plurality of subjects and a plurality of pieces of writing content according to the plurality of writing backgrounds.

The method may further include outputting at least one function button associated with the selected subject or the selected writing background onto the screen.

The method may further include receiving information informing that a fixed color button or a color change button is selected from an input apparatus including the fixed color button and the color change button; and outputting color information set in the input apparatus onto the screen based on the information.

The method may further include making the screen of the display unit interact with a screen of the user device.

The method may further include receiving a second writing input from the user device; detecting second writing content that matches the second writing input based on the selected subject or the selected writing background; and outputting the second writing content onto the screen.

The method may further include outputting a pointer visually associated with a pointer that is input to the user device onto the screen.

The method may further include: storing a student list, receiving an input instructing selection of a speaker; arbitrarily selecting a student as the speaker from the student list; and outputting a name of the selected student onto the screen.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of a configuration of an electronic device according to some exemplary embodiments;

FIG. 2 is a diagram for describing an example of a method of selecting a subject, performed by an electronic device, according to some exemplary embodiments;

FIGS. 3A and 3B are diagrams of examples of an operation of an electronic device when a selected subject is mathematics, according to some exemplary embodiments;

FIGS. 4A and 4B are diagrams of examples of an operation of an electronic device when a selected subject is geography, according to some exemplary embodiments;

FIG. 5 is a diagram for describing an example of a method of selecting a writing background, performed by an electronic device, according to some exemplary embodiments;

FIGS. 6A and 6B are diagrams of examples of an operation of an electronic device when a selected writing background is music paper, according to some exemplary embodiments;

FIGS. 7A and 7B are diagrams of examples of an operation of an electronic device when a selected writing background is graph paper, according to some exemplary embodiments;

FIG. 8 is a flowchart of a method of operating an electronic device, according to some exemplary embodiments;

FIG. 9 is a diagram of an example of function buttons for each of subjects that an electronic device outputs onto a screen, according to some exemplary embodiments;

FIGS. 10A through 10C (10A, 10B, and 10C) are diagrams of examples of an operation of an electronic device when outputting function buttons associated with English language, according to some exemplary embodiments;

FIGS. 11A through 11C (11A, 11B, and 11C) are diagrams of examples of an operation of an electronic device when outputting function buttons associated with mathematics, according to some exemplary embodiments;

FIGS. 12A through 12C (12A, 12B, and 12C) are diagrams of examples of an operation of an electronic device when outputting function buttons associated with music paper that is a selected writing background, according to some exemplary embodiments;

FIG. 13 is a flowchart of a method of operating an electronic device, according to some exemplary embodiments;

FIG. 14 is a diagram for describing an example of an operation of an electronic device, according to some exemplary embodiments;

FIG. 15 illustrates an input apparatus according to some exemplary embodiments;

FIG. 16 illustrates an electronic device and an input apparatus, according to some exemplary embodiments;

FIG. 17 illustrates an electronic device and a user device, according to some exemplary embodiments;

FIG. 18 is a diagram of an example of an electronic device and a user device that interact with each other, according to some exemplary embodiments;

FIG. 19 is a diagram of an example of an operation of an electronic device and an operation of a user device that interact with each other, according to some exemplary embodiments;

FIGS. 20 and 21 are diagrams of other examples of an operation of an electronic device and an operation of a user device that interact with each other, according to some exemplary embodiments;

FIG. 22 illustrates an input apparatus according to some exemplary embodiments;

FIG. 23 illustrates an input apparatus according to some exemplary embodiments;

FIG. 24 is a block diagram of a configuration of an input apparatus according to some exemplary embodiments;

FIG. 25 is a block diagram of a configuration of a user device according to some exemplary embodiments; and

FIG. 26 is a block diagram of a configuration of an electronic device according to some exemplary embodiments.

### DETAILED DESCRIPTION

Advantages and features of one or more embodiments of the present disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete and will fully convey the concept of the present embodiments to one of ordinary skill in the art, and the present disclosure will only be defined by the appended claims.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the present disclosure. Thus, the terms used herein have to be defined based on the meaning of the terms together with the description throughout the specification.

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, expressions such as “at least one of,” when preceding a list of elements, modify the entire list of elements and do not modify the individual elements of the list.

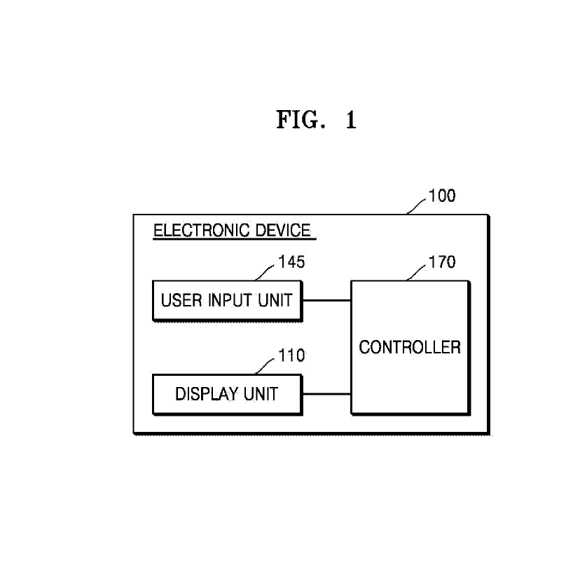

FIG. 1 is a block diagram of a configuration of an electronic device 100 according to some exemplary embodiments.

Referring to FIG. 1, the electronic device 100 may include a user input unit 145, a display unit 110, and a controller 170.

The electronic device 100 may refer to any electronic device that may be used as an electronic blackboard. That is, the electronic device 100 may be an electronic apparatus that may receive a writing input or may display writing content. Throughout the specification, the “writing content” may mean digital information that is converted from a user's analog writing input. For example, the writing content may include characters, signs, mathematical symbols, lines, images, etc. but is not limited thereto.

The electronic device 100 may generate, change, store, or output various pieces of content. Content may be generated by the electronic device 100 or may be provided over a wired and wireless communication network. Content may be digital information that may include text content (for example, lecture files, e-books (poetry and novels), letters, and work files), video content (for example, TV program images, video on demand (VOD), user-created content (UCC), music videos, Youtube images, etc.), a web page, application execution information, etc. but is not limited thereto. The electronic device 100 may schedule a plurality of pieces of content to output the plurality of pieces of content according to schedule.

The user input unit 145 means a unit used by a user to input data for controlling the electronic device 100. The user input unit 145 may receive various user inputs that may control the electronic device 100 from the user. The user input unit 145 may receive the writing input using a finger or an input apparatus. For example, the input apparatus may be a touch pen such as a stylus pen or a digitizer pen but is not limited thereto.

The user input unit 145 may receive a continuous touch on a screen of the display unit 110 by the user using the finger or the input apparatus as the writing input.

The display unit 110 may be implemented as various display apparatuses such as a liquid crystal display (LCD), a cathode ray tube (CRT) display, a plasma display panel (PDP) display, an organic light emitting diode (OLED) display, a field emission display (FED), a light emitting diode (LED) display, a vacuum fluorescence display (VFD), a digital light processing (DLP) display, a flat panel display (PFD), a 3D display, a transparent display, etc.

The controller 170 may control a general operation of the electronic device 100. The controller 170 may output a user interface (UI) on the screen. The controller 170 may control an operation of the electronic device 100 based on the user input received by the user input unit 145. The controller 170 may control an output of the screen of the display unit 110. For example, the controller 170 may include a central processing unit (CPU), a microprocessor, a graphic processing unit (GPU), etc. but is not limited thereto.

The controller 170 may output the writing content that is converted from the writing input on the screen. In a case where the writing input is generated directly by a user's finger, which may deteriorate readability. Thus, the controller 170 may analyze the writing input to change the writing input to the matching writing content such as characters, signs, mathematical symbols, lines, images, etc. and output the changed writing content on the screen, and thus readability may increase. Alternatively, the controller 170 may output the writing content on the screen in the same form as the received writing input. For example, the controller 170 may recognize a form of the received writing input as an image and may output the recognized image as it is as the writing content on the screen.

The electronic device 100 may detect the writing content that matches the writing input in consideration of a selected subject or a selected writing background. The user input unit 145 may receive an input of selecting one of a plurality of subjects or one of a plurality of writing backgrounds. The controller 170 may detect the writing content that matches the writing input based on the selected subject or the selected writing background. The controller 170 may firstly determine whether any of a plurality of pieces of writing content associated with the selected subject or the selected writing background match the writing input in order to detect the writing content that matches the writing input. That is, the controller 170 may firstly determine whether the plurality of pieces of writing content associated with the selected subject or the selected writing background match the writing input before determining whether a plurality of pieces of writing content that are not associated with the selected subject or the selected writing background match the writing input. If the plurality of pieces of writing content associated with the selected subject or the selected writing background do not match the writing input, the controller 170 may determine whether the plurality of pieces of writing content that are not associated with the selected subject or the selected writing background match the writing input.

The electronic device 100 may set a plurality of pieces of writing content according to the plurality of subjects and a plurality of pieces of writing content according to the plurality of writing backgrounds based on a frequency of use. The electronic device 100 may set, as default, the plurality of pieces of writing content according to the plurality of subjects and the plurality of pieces of writing content according to the plurality of writing backgrounds and may update the plurality of pieces of writing content according to the subjects and the plurality of pieces of writing content according to the writing backgrounds.

The electronic device 100 may further include a memory (not shown) that stores the plurality of pieces of writing content according to the plurality of subjects and the plurality of pieces of writing content according to the plurality of writing backgrounds.

A case where the user directly inputs the writing input into the electronic device 100 is described as an example above but the exemplary embodiments are not limited thereto. For example, the user may input the writing input into a user device that is an electronic apparatus different from the electronic device 100. The user device may transfer the writing input to the electronic device 100. The electronic device 100 may convert the writing input received from the user device into the writing content and may output the converted writing content onto the screen.

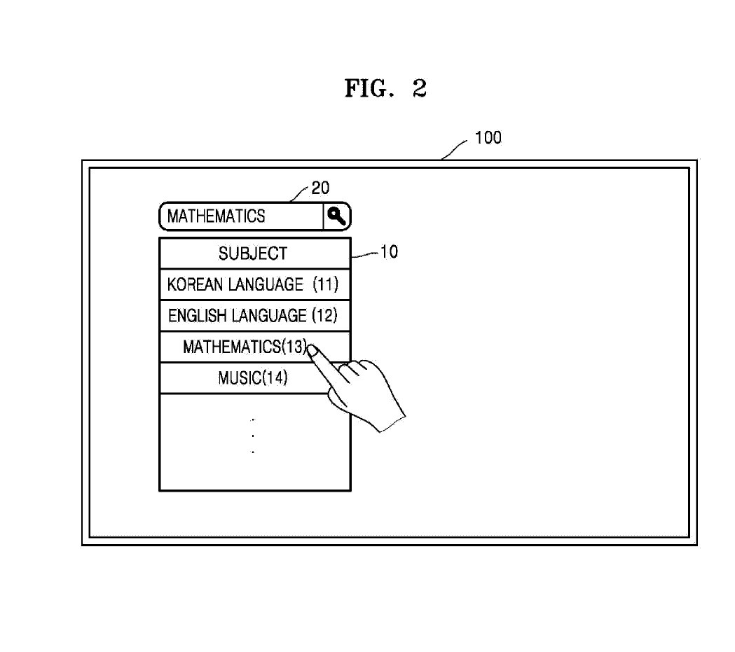

FIG. 2 is a diagram for describing an example of a method of selecting a subject, performed by the electronic device 100, according to some exemplary embodiments.

Referring to FIG. 2, the electronic device 100 may output a UI 10 that a user may use to select one of a plurality of subjects onto a screen. FIG. 2 illustrates Korean language 11, English language 12, mathematics 13, music 14, etc. as examples of the plurality of subjects but the exemplary embodiments are not limited thereto.

Alternatively, the electronic device 100 may further output a search window 20 that the user may input a subject on the screen.

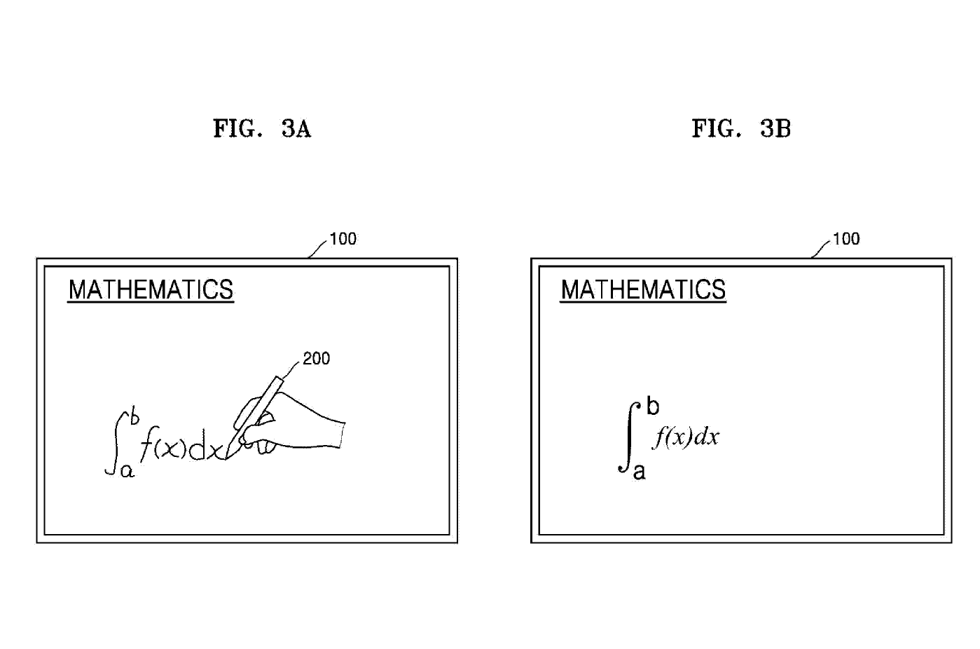

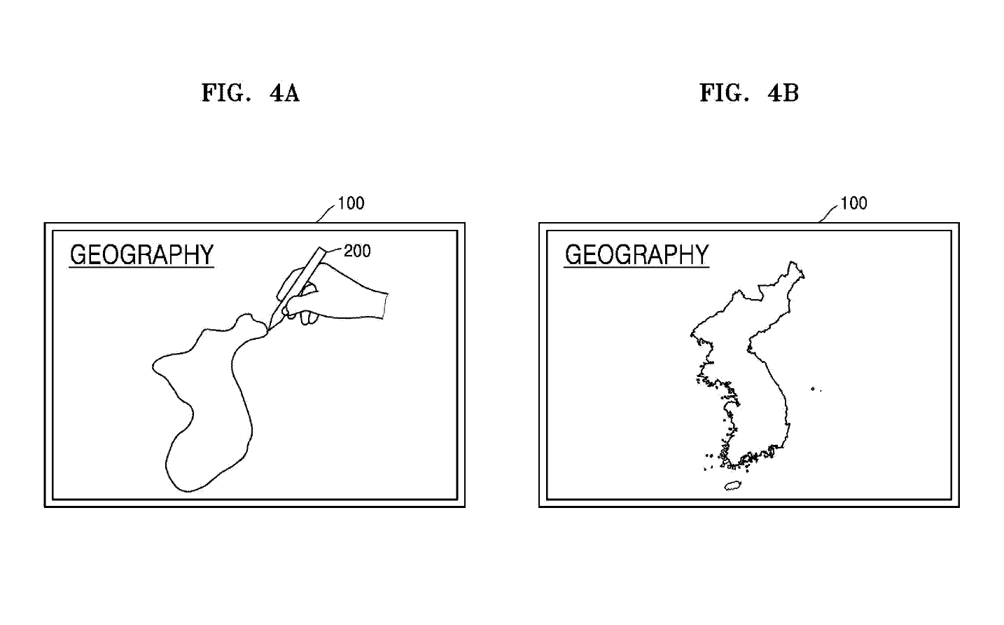

An operation of the electronic device 100 when selected subjects are mathematics and geography, according to some exemplary embodiments, will now be described with reference to FIGS. 3A through 4B below.

FIGS. 3A and 3B are diagrams of examples of an operation of the electronic device 100 when a selected subject is mathematics according to some exemplary embodiments.

Referring to FIG. 3A, the electronic device 100 may receive a writing input via an input apparatus 200. The electronic device 100 may detect writing content that matches the writing input based on mathematics that is the selected subject. The electronic device 100 may firstly determine whether any of a plurality of pieces of writing content associated with mathematics such as mathematical symbols, equations, etc. match the writing input. The electronic device 100 may detect that the writing input matches an integral and convert the writing input into writing content representing the integral. As shown in FIG. 3B, the electronic device 100 may output the converted writing content on a screen.

FIGS. 4A and 4B are diagrams of examples of an operation of the electronic device 100 when a selected subject is geography, according to some exemplary embodiments.

Referring to FIG. 4A, the electronic device 100 may receive a writing input via the input apparatus 200. The electronic device 100 may detect writing content that matches the writing input based on geography that is the selected subject. The electronic device 100 may firstly determine whether any of a plurality of pieces of writing content associated with geography such as a geographic image, etc. match the writing input. The electronic device 100 may detect that the writing input matches a geographic image of the Korean peninsula and convert the writing input into writing content representing the geographic image of the Korean peninsula. As shown in FIG. 4B, the electronic device 100 may output the converted writing content onto a screen.

As described above, the electronic device 100 may recognize writing inputs according to a plurality of subjects and convert the recognized writing inputs into a plurality of pieces of writing content.

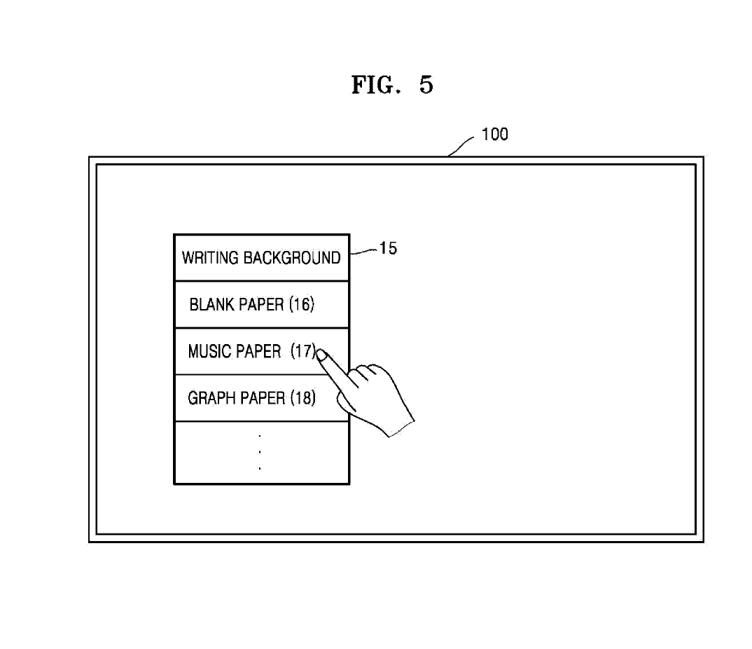

FIG. 5 is a diagram for describing an example of a method of selecting a writing background performed by the electronic device 100, according to some exemplary embodiments.

Referring to FIG. 5, the electronic device 100 may output a UI 15 that a user may use to select one of a plurality of writing backgrounds on a screen. FIG. 5 illustrates blank paper 16, music paper 17, graph paper 18, etc. as examples of the plurality of writing backgrounds but exemplary embodiments are not limited thereto.

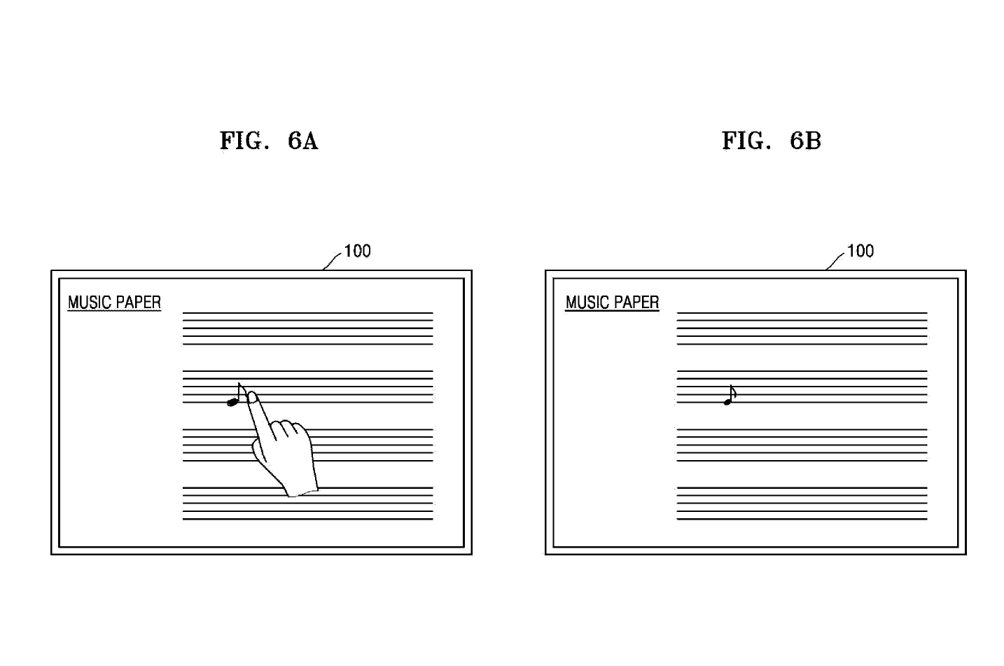

FIGS. 6A and 6B are diagrams of examples of an operation of the electronic device 100 when a selected writing background is music paper, according to some exemplary embodiments.

Referring to FIG. 6A, the electronic device 100 may output the music paper as the writing background on a screen and receive a writing input from a user. The electronic device 100 may detect writing content that matches the writing input based on the music paper that is the selected writing background. The electronic device 100 may firstly determine whether any of a plurality of pieces of writing content associated with the music paper such as a note, a rest, a musical sign, etc. match the writing input. The electronic device 100 may detect that the writing input matches an eighth note and convert the writing input into writing content of the eighth note. As shown in FIG. 6B, the electronic device 100 may output the converted writing content onto the screen.

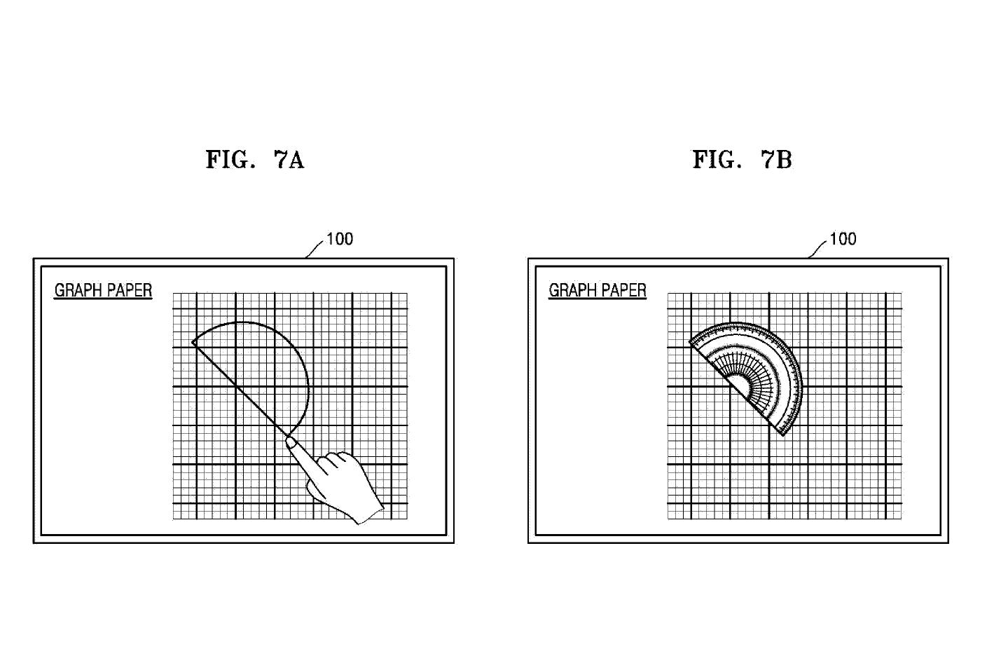

FIGS. 7A and 7B are diagrams of examples of an operation of the electronic device 100 when a selected writing background is graph paper, according to some exemplary embodiments.

Referring to FIG. 7A, the electronic device 100 may output the graph paper as the writing background onto a screen and receive a writing input from a user. The electronic device 100 may detect writing content that matches the writing input based on the graph paper that is the selected writing background. As shown in FIG. 7A, if the electronic device 100 receives the writing input that is a semi-circular image from the user, the electronic device 100 may detect that the writing input matches an image of a protractor and convert the writing input into writing content of the image of the protractor. As shown in FIG. 7B, the electronic device 100 may output the converted writing content onto the screen.

As described above, the electronic device 100 may recognize writing inputs according to a plurality of writing backgrounds and convert the recognized writing inputs into a plurality of pieces of writing content.

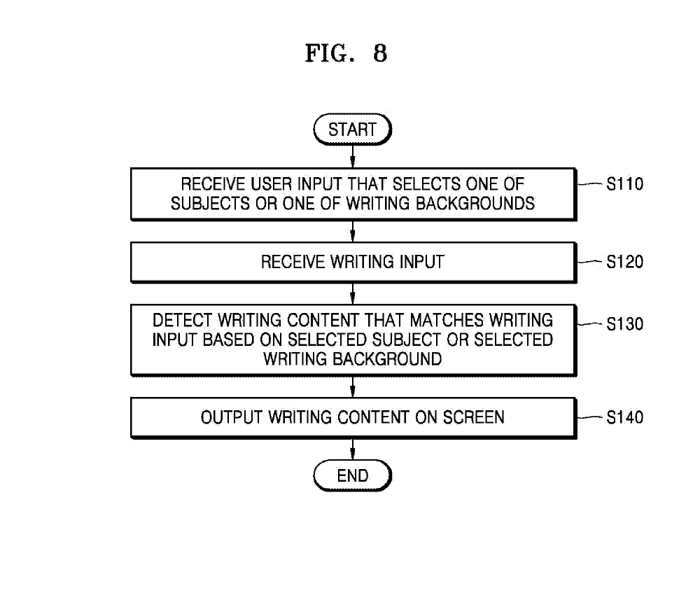

FIG. 8 is a flowchart of a method of operating an electronic device, according to some exemplary embodiments.

Referring to FIG. 8, the electronic device may receive a user input that selects one of a plurality of subjects or one of a plurality of writing backgrounds (operation S110). The electronic device may receive a writing input (operation S120). The electronic device may receive the writing input directly from a user or from another user device.

The electronic device may detect writing content that matches the writing input based on the selected subject or the selected writing background (operation S130). The electronic device may output the writing content on a screen of the electronic device (operation S140).

The method of operating the electronic device may be performed by the electronic device 100 described above. Each operation of the method of operating the electronic device may be performed as described above.

According to some exemplary embodiments, the electronic device may accurately and promptly detect writing content that matches a writing input, and thus readability may be enhanced, and user convenience and satisfaction may also increase. The electronic device may set a range of writing content that may match a writing input according to a selected subject or a selected writing background, thereby reducing an overhead of a data processing process for converting the writing input of the electronic device into the writing content.

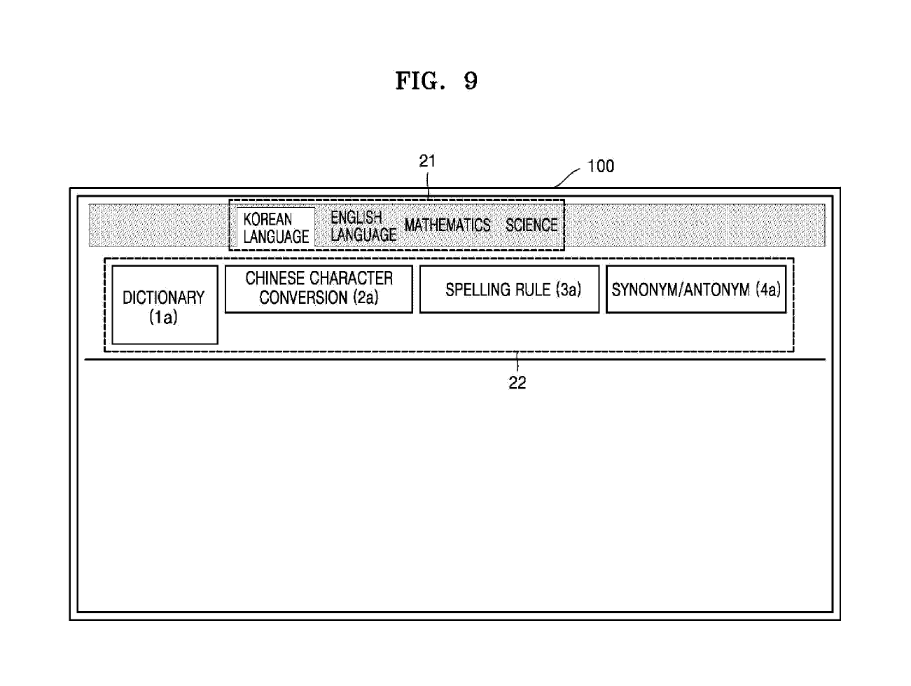

FIG. 9 is a diagram of an example of function buttons for each of a plurality of subjects that the electronic device 100 outputs onto a screen, according to some exemplary embodiments.

Referring to FIG. 9, the electronic device 100 may output a tab menu 21 from which one of the plurality of subjects may be selected on the screen. FIG. 9 illustrates Korean language, English language, mathematics, science, etc. as examples of the plurality of subjects that may be selected from the tab menu 21 but the exemplary embodiments are not limited thereto. The electronic device 100 may output a function window 22 that provides one or more function buttons associated with the selected subject on the screen. As shown in FIG. 9, if the Korean language is selected as one subject from the tab menu 21, the function window 22 may provide one or more function buttons 1a˜4a (1a, 2a, 3a and 4a) associated with the Korean language. FIG. 9 illustrates that the function window 22 provides a dictionary button 1a, a Chinese character conversion button 2a, a spelling rule button 3a, and a synonym/antonym button 4a but the exemplary embodiments are not limited thereto. If another subject is selected, the function window 22 may provide one or more function buttons associated with the selected other subject. As described above, if the electronic device 100 selects one of the plurality of subjects from the tab menu 21, the electronic device 100 may output the function window 22 providing one or more function buttons associated with the selected subject on the screen. If a user selects a function button, the electronic device 100 may perform a function provided by the function button. For example, if the dictionary button 1a is selected, a Korean dictionary button may be performed, and, if the Chinese character conversion button 2a is selected, a function of converting Korean into Chinese may be performed. If the spelling rule button 3a is selected, a spelling rule review function may be performed. If the synonym/antonym button 4a is selected, a synonym/antonym dictionary function may be performed. However, these are merely examples, and the exemplary embodiments are not limited thereto.

The electronic device 100 may select one of the plurality of subjects from the tab menu 21 in FIG. 9 but is not limited thereto. As shown in FIG. 2, the electronic device 100 may provide a UI from which a subject may be selected. In this case, the tab menu 21 of FIG. 9 may be omitted. The electronic device 100 may output one or more function buttons associated with the selected subject on the screen without the function window 22.

The electronic device 100 may output one or more function buttons associated with a writing background selected from among a plurality of writing backgrounds on the screen.

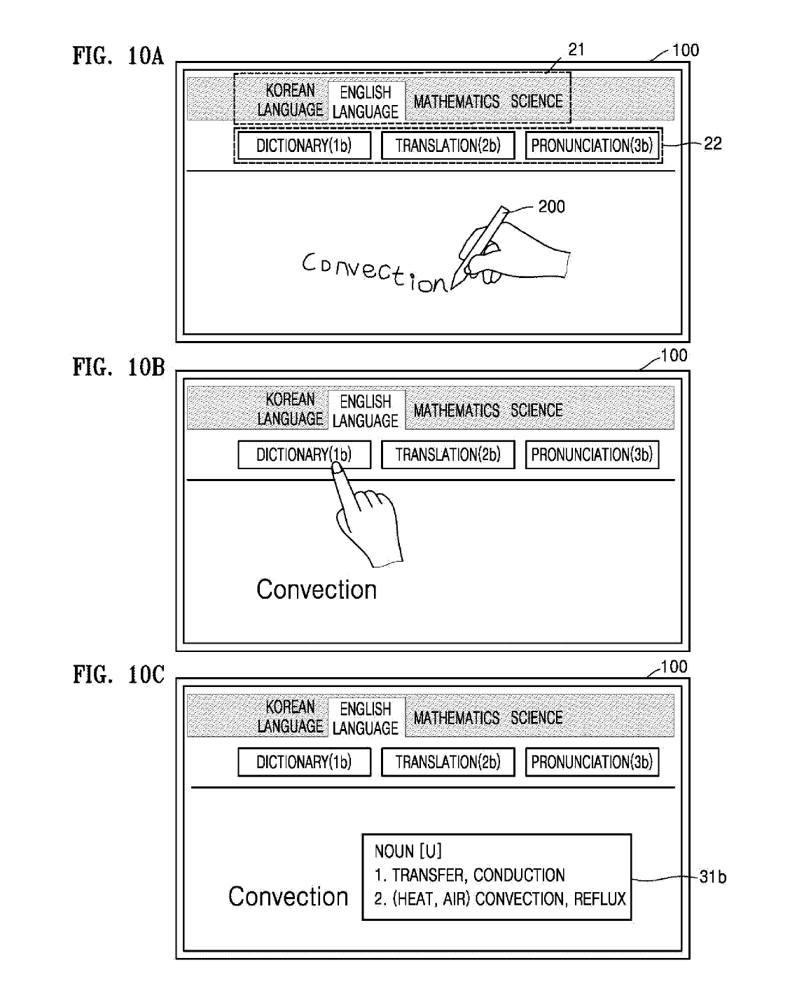

FIGS. 10A through 10C are diagrams of examples of an operation of the electronic device 100 when outputting one or more function buttons 1b˜3b (1b, 2b and 3b) associated with the English language, according to some exemplary embodiments.

Referring to FIG. 10A, if the English language is selected as one subject from the tab menu 21, the function window 22 may provide the one or more function buttons 1b˜3b associated with the English language. FIGS. 10A through 10C illustrate that the function window 22 provides a dictionary button 1b, a translation button 2b, and a pronunciation button 3b but the exemplary embodiments are not limited thereto.

The electronic device 100 may receive a writing input via the input apparatus 200, etc. Since the selected subject is the English language, the electronic device 100 may detect writing content that matches the writing input based on the English language. The electronic device 100 may detect that the writing input matches the English alphabet and convert the writing input into the English alphabet.

Referring to FIG. 10B, the electronic device 100 may output the converted writing content onto a screen. The electronic device 100 may output an English word “convection” on the screen as shown in FIG. 10B. The electronic device 100 may select the dictionary button 1b in response to a user input.

Referring to FIG. 100, if the dictionary button 1b is selected by a user, the electronic device 100 may perform a dictionary function that the dictionary button 1b provides, and thus the electronic device 100 may further output a window 31b that provides the dictionary function with respect to the English word “convection” onto the screen.

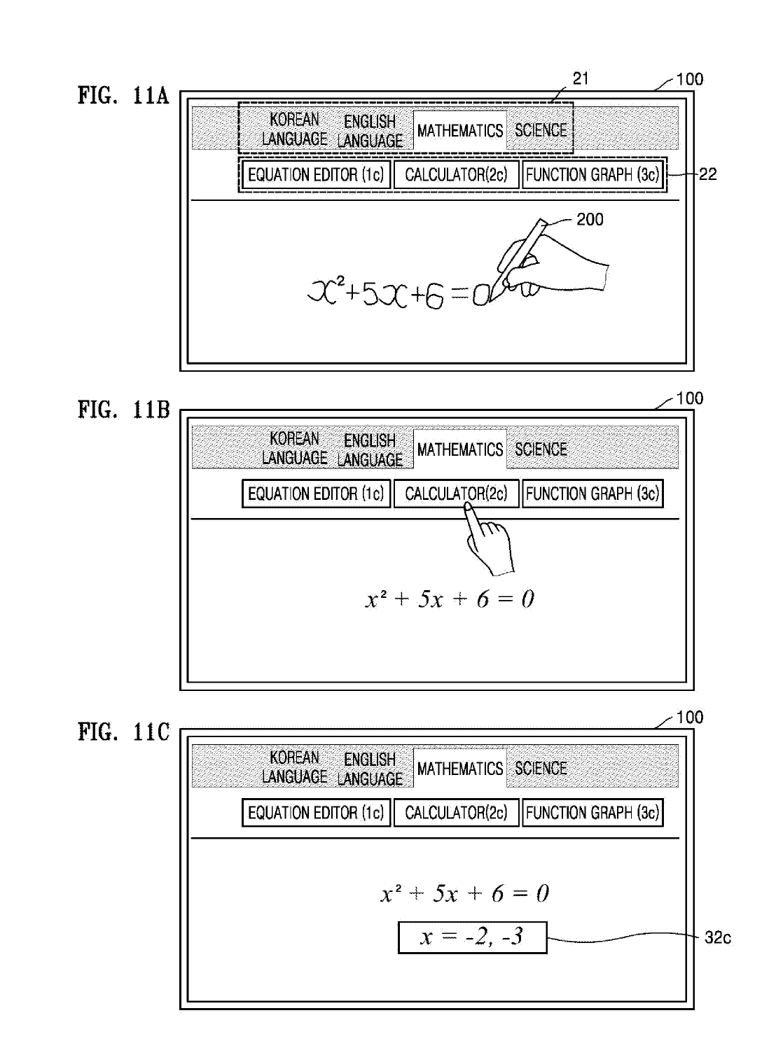

FIGS. 11A through 11C are diagrams of examples of an operation of the electronic device 100 when outputting one or more function buttons 1c˜3c (1c, 2c and 3c) associated with mathematics, according to some exemplary embodiments.

Referring to FIG. 11A, if mathematics is selected as one subject from the tab menu 21, the function window 22 may provide the one or more function buttons 1c˜3c associated with mathematics. FIGS. 11A through 11C illustrate that the function window 22 provides an equation editor button 1c, a calculator button 2c, and a graph function (function graph) button 3c but the exemplary embodiments are not limited thereto. The electronic device 100 may receive a writing input via the input apparatus 200. Since the selected subject is mathematics, the electronic device 100 may detect writing content that matches the writing input based on mathematics. The electronic device 100 may detect that the writing input matches a quadratic equation and convert the writing input into the quadratic equation.

Referring to FIG. 11B, the electronic device 100 may output the converted writing content onto a screen. The electronic device 100 may output a quadratic equation “X²+5x+6=0” onto the screen as shown in FIG. 11B. The electronic device 100 may select the calculator button 2c in response to a user input.

Referring to FIG. 11C, if the calculator button 2c is selected by the user, the electronic device 100 may perform a calculator function that the calculator button 2c provides, and thus the electronic device 100 may further output a window 32c that provides a calculation result of the quadratic equation “X²+5x+6=0” onto the screen.

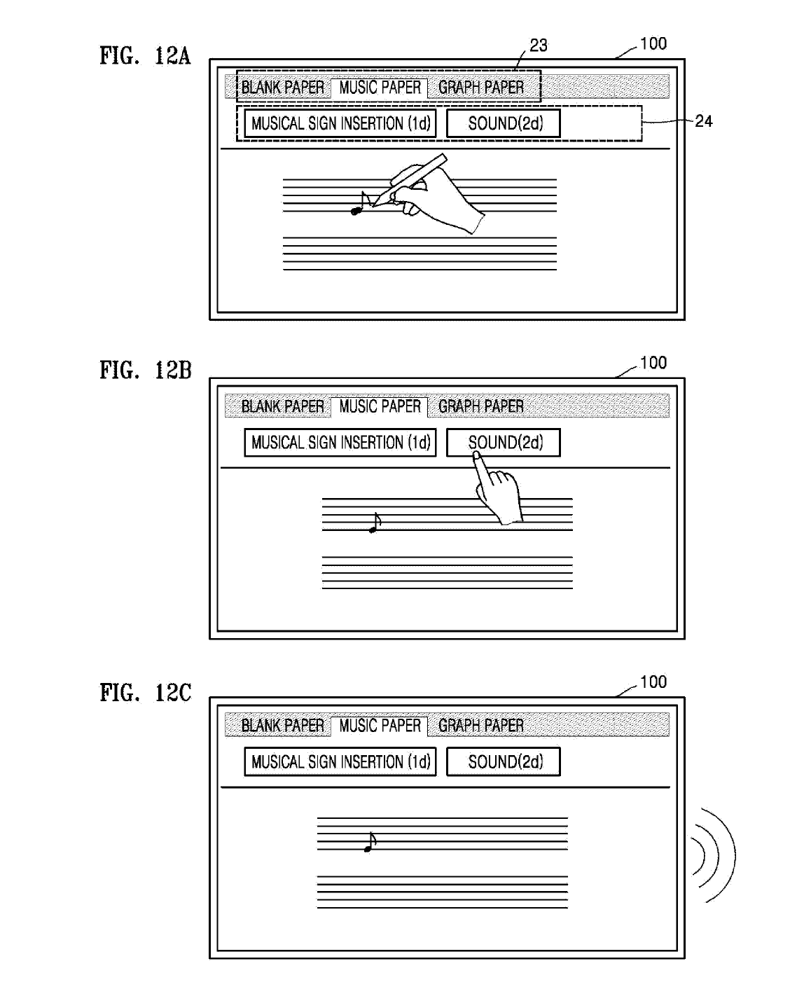

FIGS. 12A through 12C are diagrams of examples of an operation of the electronic device 100 when outputting function buttons 1d and 2d associated with music paper that is a selected writing background, according to some exemplary embodiments.

Referring to FIGS. 12A through 12C, the electronic device 100 may output a tab menu 23 from which one of a plurality of writing backgrounds may be selected onto a screen. FIGS. 12A through 12C illustrate blank paper, music paper, graph paper, etc. as examples of the plurality of writing backgrounds that may be selected from the tab menu 23 but the exemplary embodiments are not limited thereto. The electronic device 100 may output a function window 24 that provides one or more function buttons associated with the selected writing background onto the screen. If the music paper is selected as the one writing background from the tab menu 23 as shown in FIGS. 12A through 12C, the function window 24 may provide the one or more function buttons 1d and 2d associated with the music paper. FIGS. 12A through 12C illustrate that the function window 24 provides a musical sign insertion button 1d and a sound button 2d but the exemplary embodiments are not limited thereto. If another writing background is selected, the function window 24 may provide one or more function buttons associated with the selected writing background. As described above, if the electronic device 100 selects one of the plurality of writing backgrounds from the tab menu 23, the electronic device 100 may output the function window 24 that provides one or more function buttons associated with the selected writing background onto the screen. If a function button is selected by a user, the electronic device 100 may perform a function that the function button provides.

Unlike the description of FIGS. 12A through 12C, the electronic device 100 may provide a UI from which a writing background may be selected as shown in FIG. 5, and may omit the tab menu 23. The electronic device 100 may output one or more function buttons associated with the selected writing background onto the screen without the function window 24.

Referring to FIG. 12A, the electronic device 100 may receive a writing input via the input apparatus 200. Since the selected writing background is the music paper, the electronic device 100 may detect writing content that matches the writing input based on the music paper. The electronic device 100 may detect that the writing input is an eighth note and convert the writing input into the eighth note.

Referring to FIG. 12B, the electronic device 100 may output converted writing content on the screen. The electronic device 100 may output the converted eighth note as the writing content on the screen as shown in FIG. 12B. The electronic device 100 may select the sound button 2d by a user input.

Referring to FIG. 12C, if the sound button 2d is selected by the user, the electronic device 100 may perform a sound function that the sound button 2d provides, and thus the electronic device 100 may output sound of the eighth note on the music paper output onto the screen.

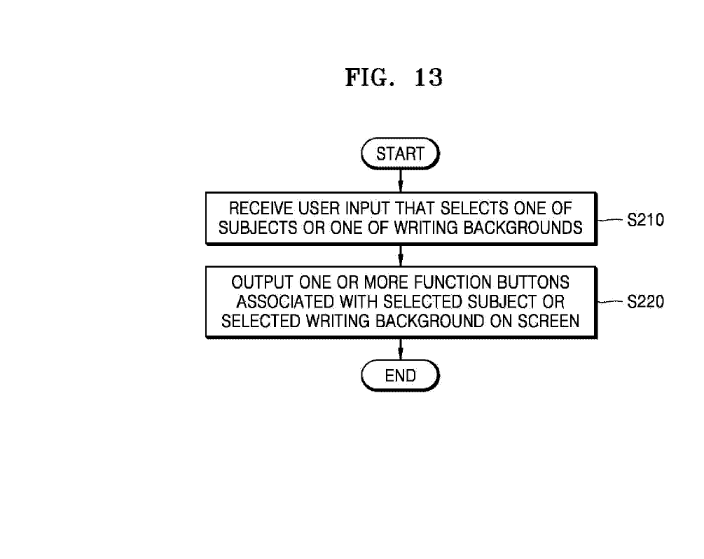

FIG. 13 is a flowchart of a method of operating an electronic device according to some exemplary embodiments.

Referring to FIG. 13, the electronic device may receive a user input that selects one of a plurality of subjects or one of a plurality of writing backgrounds (operation S210). The electronic device may output one or more function buttons associated with the selected subject or the selected writing background onto a screen (operation S220).

The method of operating the electronic device may be performed by the electronic device 100 described above. Each operation of the method of operating the electronic device may be performed as described above.

According to some exemplary embodiments, the electronic device may set one or more function buttons according to a plurality of subjects and one or more function buttons according to a plurality of writing backgrounds based on a frequency of use. The electronic device may set the one or more function buttons according to the plurality of subjects and the one or more function buttons according to the plurality of writing backgrounds as default and may update the one or more function buttons according to the plurality of subjects and the one or more function buttons according to the plurality of writing backgrounds.

According to some exemplary embodiments, the electronic device may determine function buttons that are output onto a screen based on a selected subject or a selected writing background, and thus a user may conveniently use a function of the electronic device associated with the selected subject or the selected writing background. Accordingly, the electronic device needs not simultaneously output many function buttons onto the screen while providing various functions for each subject or for each writing background. The electronic device may output an optimized function button only according to the selected subject or the selected writing background to allow the user to appropriately use various functions, and thus user convenience and satisfaction may increase.

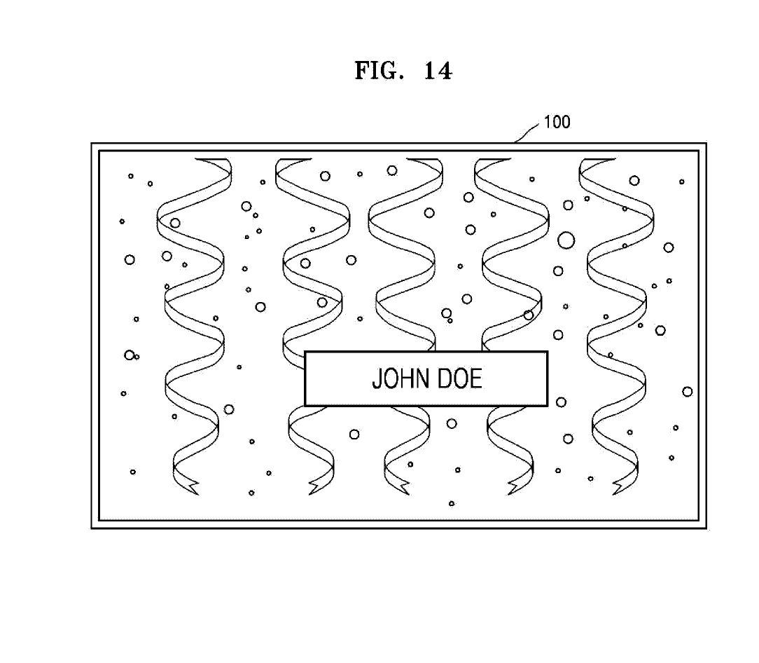

FIG. 14 is a diagram for describing an example of an operation of the electronic device 100 according to some exemplary embodiments.

Referring to FIG. 14, the electronic device 100 may select a student from a student list and output a name of the selected student “John Doe” on a screen. The electronic device 100 may arbitrarily select the student from the student list. To this end, the electronic device 100 may receive an input instructing selection of a speaker. The electronic device 100 may output a UI such as a button that may instruct the selection of the speaker onto the screen.

Before receiving the input instructing the selection of the speaker and then outputting the name of a student selected as the speaker, the electronic device 100 may sequentially output names of students included in the student list on the screen. The electronic device 100 may further include a memory (not shown) that stores the student list.

According to some exemplary embodiments, since the electronic device 100 may automatically arbitrarily select a speaker from among a plurality of students, the user may not need to worry about who is selected as the speaker from among the plurality of students. Accordingly, user convenience may increase, and excitement and fun may be provided for students.

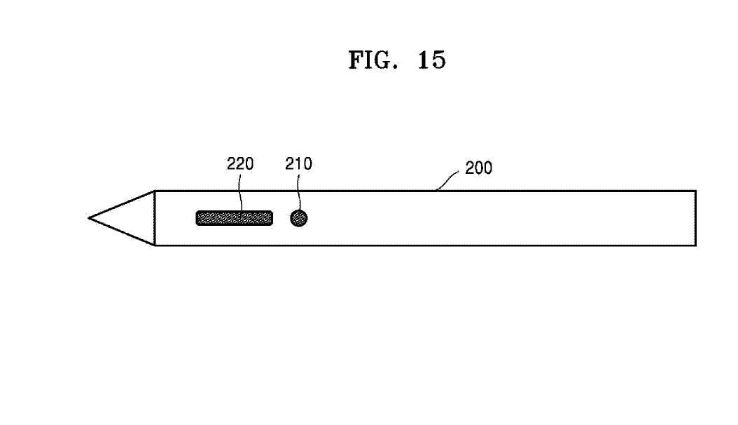

FIG. 15 illustrates the input apparatus 200 according to some exemplary embodiments. The input apparatus 200 may be a unit used by a user to input a writing input and various user inputs into an electronic device (100 of FIG. 1) according to some exemplary embodiments.

Referring to FIG. 15, the input apparatus 200 may include a fixed color button 210 and a color change button 220. The user may select the fixed color button 210 or the color change button 220 to set a color used by the input apparatus 200. The color used by the input apparatus 200 may mean a color of writing content output by the electronic device (100 of FIG. 1) onto a screen that receives a writing input via the input apparatus 200.

If the fixed color button 210 is selected by the user, the color used by the input apparatus 200 may be set as a fixed color. In this case, if the electronic device (100 of FIG. 1) receives the writing input via the input apparatus 200, the electronic device (100 of FIG. 1) may output the writing content in the fixed color on the screen.

The color change button 220 may be used to change the color of the input apparatus 200 to one of a plurality of colors. Whenever the color change button 220 is selected by the user, the color of the input apparatus 200 may be changed from one of the plurality of colors to other colors in a predetermined order. For example, the color of the input apparatus 200 may be changed to one of red, green, and blue through the color change button 220. Whenever the color change button 220 is selected, the color of the input apparatus 200 may be changed from red to green, from green to blue, or from blue to red. For example, when the color of the input apparatus 200 is changed from green to blue through the color change button 220, if the electronic device (100 of FIG. 1) receives the writing input via the input apparatus 200, the electronic device (100 of FIG. 1) may output the writing content in blue on the screen. However, this is merely an example, and the fixed color, the plurality of colors, and a color change order may be in a variety of combinations. The fixed color, the plurality of colors, and the color change order may be set or reset by the user.

The color change button 220 may include a light emitting device configured to emit the plurality of colors. For example, the light emitting device may be a light emitting diode (LED). Thus, the color change button 220 may present the color of the input apparatus 200 via the light emitting device. For example, if the color of the input apparatus 200 is green, the light emitting device of the color change button 220 may emit green. If the color of the input apparatus 200 is changed from green to red, the color change button 220 may emit green via the light emitting device and then emit red.

Therefore, the user may intuitively recognize the color of the input apparatus 200 from a color that the color change button 220 emits.

The fixed color button 210 may also include a light emitting device configured to emit the fixed color. Thus, if the color of the input apparatus 200 is set as the fixed color by a selection of the fixed color button 210, the light emitting device of the fixed color button 210 may emit the fixed color (for example, black). For example, if the color of the input apparatus 200 is changed from green to the fixed color (for example, black), the color change button 220 may stop emitting green, and the fixed color button 210 may emit black.

As another example, the fixed color button 210 may not include the light emitting device. If the color of the input apparatus 200 is the fixed color, both the color change button 220 and the fixed color button 210 may not emit colors. That is, when the color change button 220 and the fixed color button 210 do not emit colors, the user may recognize that the color of the input apparatus 200 may be the fixed color.

As described above, the user may easily set and change the color of the input apparatus 200 via the input apparatus 200 according to some exemplary embodiments. When the fixed color may be set as a color having a high frequency of use, the user may select the fixed color button 210 to allow the color of the input apparatus 200 to be immediately returned to the fixed color. Accordingly, user convenience and satisfaction may increase.

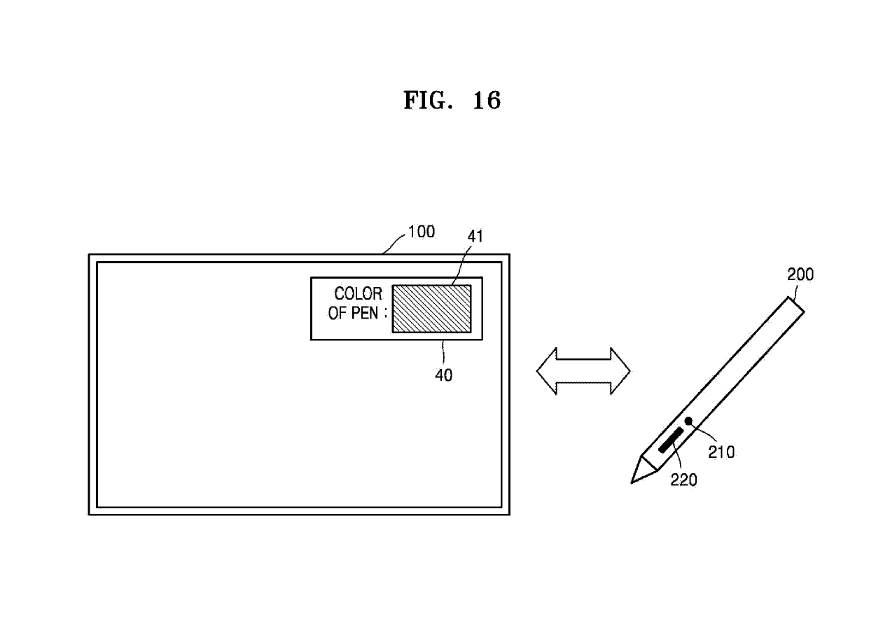

FIG. 16 illustrates the electronic device 100 and the input apparatus 200 according to some exemplary embodiments.

Referring to FIG. 16, the electronic device 100 and the input apparatus 200 may be connected to communicate with each other according to various types of communication methods. For example, communication methods may include a WiFi method, a Bluetooth method, a wireless communication method, a near field communication (NFC) method, etc. To this end, each of the electronic device 100 and the input apparatus 200 may include a communication unit (not shown) that may include at least one of a WiFi chip, a Bluetooth chip, a wireless communication chip, and an NFC chip.

The electronic device 100 may output color information 41 indicating a color that is set in the input apparatus 200 on a screen. The color information 41 may be output by being included in an input apparatus color window 40. The color information 41 may indicate the color that is set in the input apparatus 200 through at least one of colors and text. For example, if the color set in the input apparatus 200 is black, the color information 41 may indicate black. If the color change button 220 of the input apparatus 200 is selected by the user, and a color of the input apparatus 200 is changed to red, the color information 41 may be changed to indicate the change to red from black.

The electronic device 100 may transfer information indicating the color that is set in the input apparatus 200 to the input apparatus 200.

The input apparatus 200 may determine the color that is set in the input apparatus 200 based on the information transferred from the electronic device 100. The input apparatus 200 may emit light via a light emitting device of the color change button 220 or the fixed color button 210 in the determined color. If the color change button 220 or the fixed color button 210 is selected by the user, the input apparatus 200 may transfer information indicating that the color change button 220 or the fixed color button 210 is selected to the electronic device 100.

Therefore, the electronic device 100 may receive the information indicating that the color change button 220 or the fixed color button 210 is selected from the input apparatus 200.

The electronic device 100 may change the color that is set in the input apparatus 200 based on the received information. The electronic device 100 may output the color information 41 indicating the changed color of the input apparatus 200 onto the screen. This may be performed by a controller (170 of FIG. 1). The electronic device 100 may transfer information regarding the changed color of the input apparatus 200 to the input apparatus 200.

The input apparatus 200 may determine the changed color of the input apparatus 200 based on the information transferred from the electronic device 100 and emit light from the light emitting device in the determined color. As described above, the input apparatus 200 may transfer the information indicating that the color change button 220 or the fixed color button 210 is selected and receive the information regarding the color that is set in the input apparatus 200 from the electronic device 100, and thus the color of the input apparatus 200 may be set or changed.

According to some exemplary embodiments, the user may easily and intuitively recognize the color of the input apparatus 200 based on the color information 41 that is output on the screen of the electronic device 100. When the color change button 220 and the fixed color button 210 of the input apparatus 200 include light emitting devices, the user may easily and intuitively recognize the color of the input apparatus 200 based on colors that the color change button 220 and the fixed color button 210 of the input apparatus 200 emit.

The user may easily change the color of the input apparatus 200 through a selection of the color change button 220 or the fixed color button 210. According to some exemplary embodiments, the user may easily change the color of the input apparatus 200 without having to search for a menu to change a color of writing content in the electronic device 100. While changing the color of the input apparatus 200, the user may easily and intuitively recognize the changed color based on the color information 41 that is output on the electronic device 200. Accordingly, user convenience and satisfaction may increase.

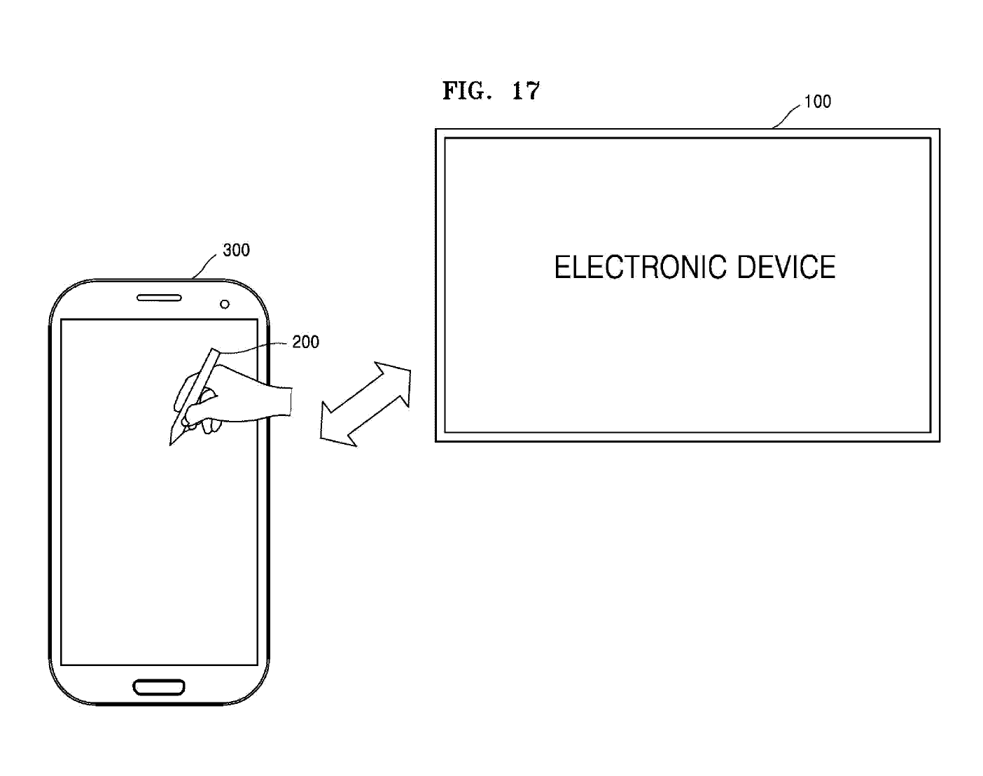

FIG. 17 illustrates the electronic device 100 and a user device 300 according to some exemplary embodiments.

Referring to FIG. 17, the electronic device 100 may be connected to the user device 300. The user device 300 may be connected to the electronic device 100 using various types of communication methods. Each of the electronic device 100 and the user device 300 may further include a communication unit (not shown) configured to communicate with each other.

The user device 300 may be any electronic apparatus that is connectable to the electronic device 100. The user device 300 may be a smart phone, a tablet personal computer (PC), a PC, a smart TV, a cellular phone, a personal digital assistant (PDA), a laptop computer, a media player, a micro server, a global positioning system (GPS) unit, an e-book terminal, a digital broadcasting terminal, a navigation system, a kiosk, an MP3 player, a digital camera, another mobile apparatus, or a non-mobile computing apparatus but is not limited thereto.

The electronic device 100 and the user device 300 may share content with each other.

The electronic device 100 and the user device 300 may interact with each other. For example, a screen of the electronic device 100 may interact with a screen of the user device 300. That is, the electronic device 100 may output the screen in the same manner as the user device 300. If the user device 300 generates, changes, stores, or outputs content, the electronic device 100 that interacts with the user device 300 may also generate, change, store, or output the content. Likewise, if the electronic device 100 generates, changes, stores, or outputs the content, the user device 300 that interacts with the electronic device 100 may also generate, change, store, or output the content. The user device 300 or the electronic device 100 may schedule a plurality of pieces of content and may store scheduling information in the user device 300 or electronic device 100 that interacts with each other.

As described above, according to some exemplary embodiments, the convenience of use of the electronic device 100 may increase due to the user device 300. Since content for a lecture may be stored in the user device 300, even if a lecture room may be changed, the content stored in the user device 300 may be easily used in another electronic device of another lecture room. That is, inconvenience of having to move content stored in the electronic device 100 to another electronic device present in another lecture room whenever the lecture rooms are changed may be greatly reduced. Accordingly, user convenience and satisfaction may increase.

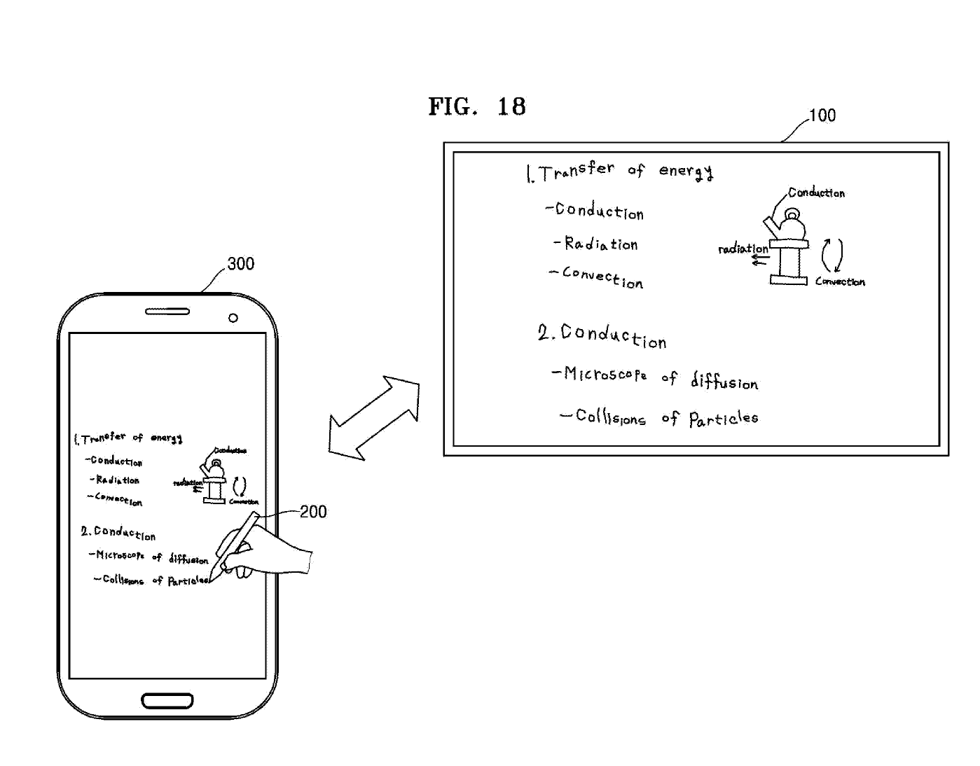

FIG. 18 is a diagram of an example of the electronic device 100 and the user device 300 that interact with each other according to some exemplary embodiments.

Referring to FIG. 18, the user device 300 may receive a writing input or may output writing content onto a screen. The user device 300 may receive the writing input from a user using a finger or the input apparatus 200.

If the user device 300 outputs the writing content onto the screen, the electronic device 100 that interacts with the user device 300 may also output the same writing content as that output by the user device 300 onto the screen.

Likewise, the electronic device 100 may also receive a writing input or may output writing content onto a screen as described above. If the electronic device 100 receives the writing input and outputs the writing content onto the screen, the user device 300 may also output the same writing content as that output by the electronic device 100 onto the screen.

FIG. 18 illustrates that the user device 300 outputs the writing content in the same form as that of the received writing input onto the screen but the exemplary embodiments are not limited thereto. As described with respect to the electronic device 100 above, the writing input received by the user device 300 may be converted into writing content of a different form from that of the writing input by the user device 300 or the electronic device 100 so that the converted writing content may be output onto the screen of the user device 300 and the screen of the electronic device 100.

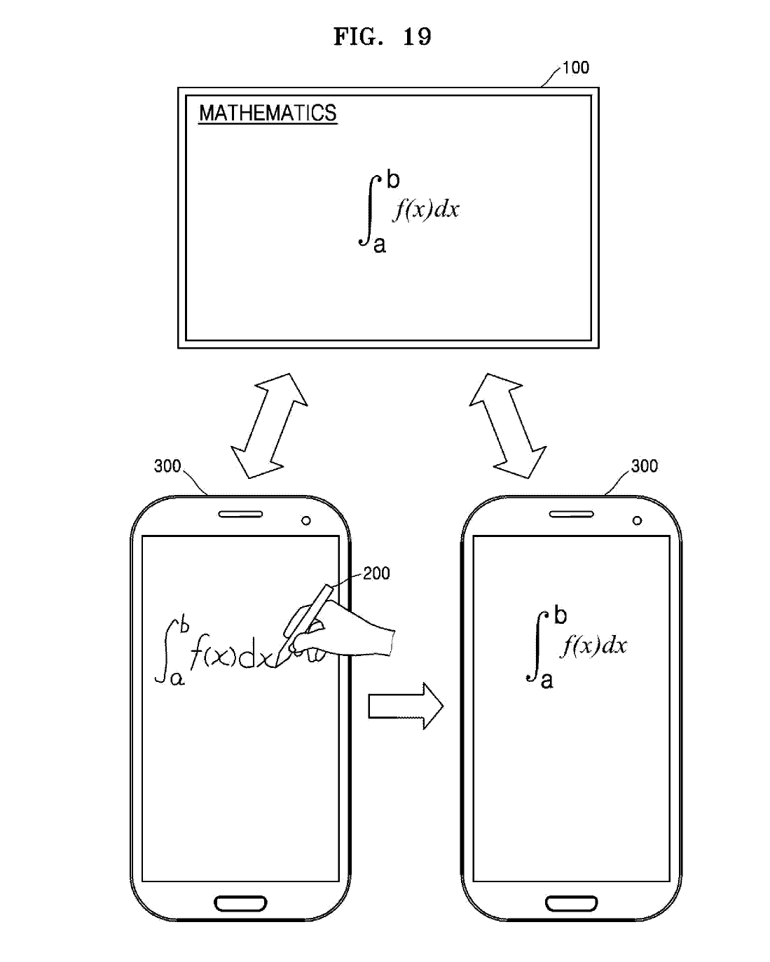

FIG. 19 is a diagram of an example of an operation of the electronic device 100 and an operation of the user device 300 that interact with each other according to some exemplary embodiments.

Referring to FIG. 19, the user device 300 may receive a writing input from the user using a finger or the input apparatus 200. The user device 300 may transfer the writing input to the electronic device 100.

The electronic device 100 that receives the writing input from the user device 300 may detect writing content that matches the writing input based on a selected subject or a selected writing background and may output the detected writing content onto a screen. That is, when the electronic device 100 does not receive the writing input directly through a user input unit (110 of FIG. 1) but receives the writing input through the user device 300, the above-mentioned description that the electronic device 100 detects the writing content that matches the writing input from among a plurality of pieces of writing content associated with the selected subject or the selected writing background and outputs the detected writing content may apply.

If the electronic device 100 outputs the writing content onto the screen, the user device 300 that interacts with the electronic device 100 may also output the writing content in the same manner as the electronic device 100. To this end, the electronic device 10 may transfer the detected writing content to the user device 300.

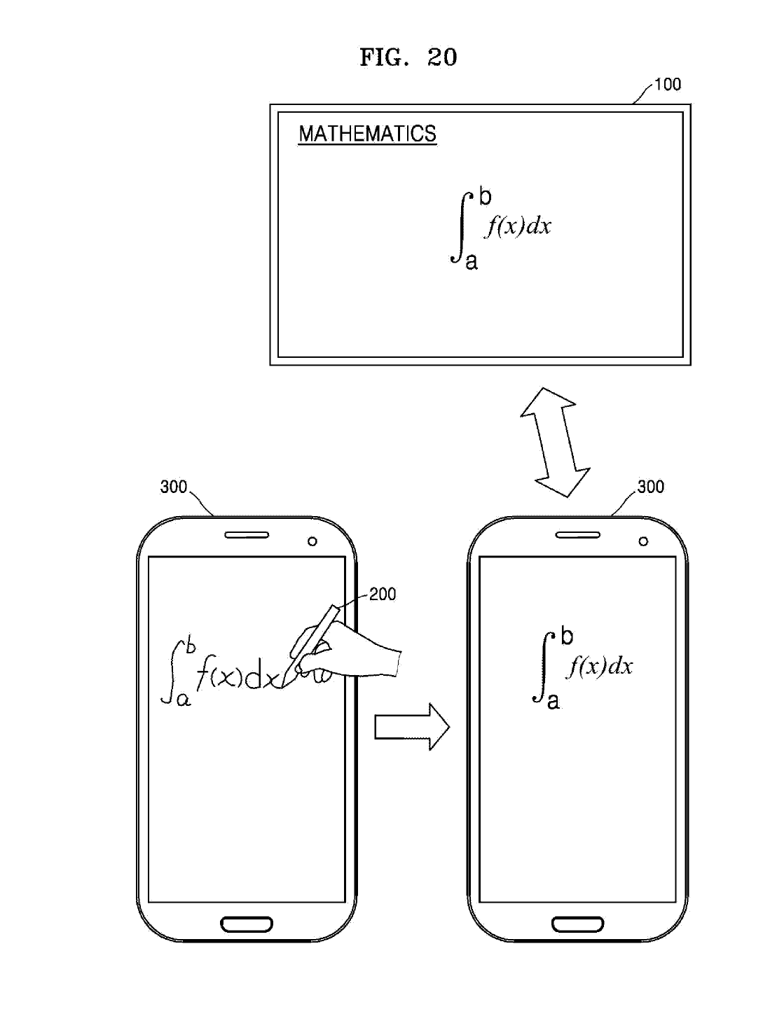

FIG. 20 is a diagram of another example of an operation of the electronic device 100 and an operation of the user device 300 that interact with each other according to some exemplary embodiments.

Referring to FIG. 20, the user device 300 may receive a writing input from the user using a finger or the input apparatus 200. Like the above-described operation of the electronic device 100, the user device 300 may also detect writing content that matches the writing input based on a selected subject or a selected writing background and may output the detected writing content onto a screen of the user device 300.

The user device 300 may transfer the detected writing content to the electronic device 100. The electronic device 100 may output the received writing content onto a screen of the electronic device 100.

Which of the methods described with reference to FIGS. 19 and 20 is applied to the operation of the electronic device 100 and the operation of the user device 300 may differ according to an implementation example.

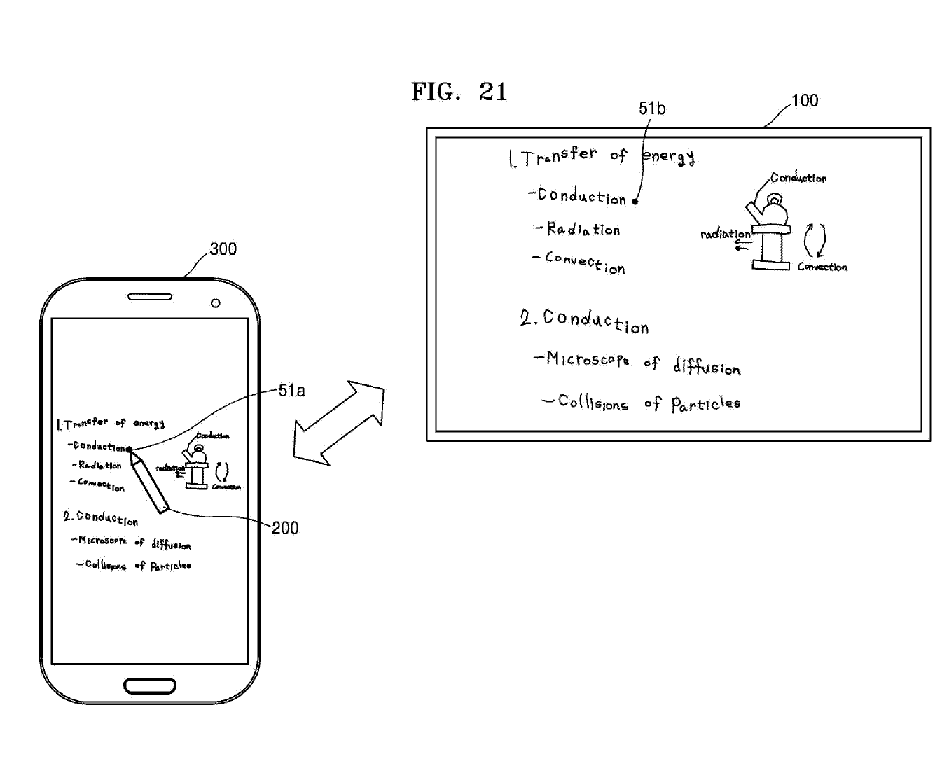

FIG. 21 is a diagram of another example of an operation of the electronic device 100 and an operation of the user device 300 that interact with each other according to some exemplary embodiments.

Referring to FIG. 21, the user device 300 may receive an input of a pointer 51a on a screen. The user device 300 may receive the input of the pointer 51a from the user using a finger or the input apparatus 200. In this regard, the user device 300 may operate in a pointing mode in order to recognize a touch of the finger or the input apparatus 200 as a pointing input other than a writing input. Meanwhile, the user device 300 of FIGS. 18 through 20 may operate in a writing mode. The user device 300 may operate in one of a plurality of modes including the writing mode and the pointing mode.

If the user device 300 receives the input of the pointing 51a, the electronic device 100 that interacts with the user device 300 may output a pointer 51b that is visually associated with the pointer 51a that is input on the screen of the user device 300 onto a screen of the electronic device 100.

According to some exemplary embodiments, a restriction due to limited space in which a user has to lecture in front of the electronic device 100 may be removed by combining the electronic device 100 and the user device 300. The user may explain content output by the electronic device 100 while freely moving in a lecture space by carrying the user device 300. Content written on the user device 300 may be also output by the electronic device 100, and thus a space restriction may be removed, thereby increasing user convenience. The user may output a pointer on a desired part of the screen of the electronic device 100 through the user device 300, thereby removing a space restriction for using the electronic device 100. Accordingly, user convenience and satisfaction may increase.

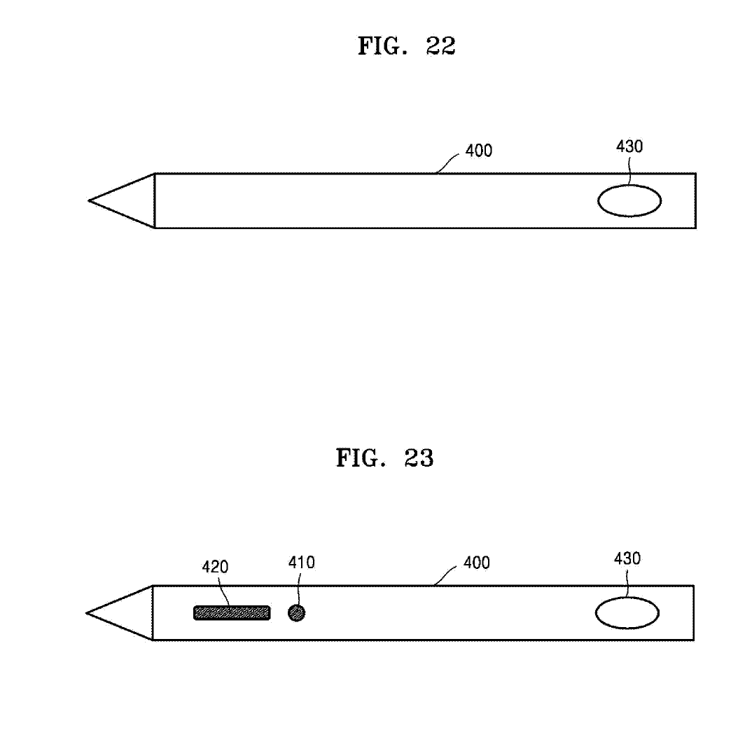

FIG. 22 illustrates an input apparatus 400 according to some exemplary embodiments.

Referring to FIG. 22, the input apparatus 400 may be a unit used for inputting writing onto a screen of an electronic apparatus. The electronic apparatus may be the electronic device 100 or the user device 300 described above.

The input apparatus 400 may include a mode change button 430. If the mode change button 430 is selected by a user, the electronic apparatus may change a mode to one of a plurality of modes and operate in the changed mode. For example, the plurality of modes may include a writing mode and a pointing mode. If the mode change button 430 is selected, the electronic apparatus may be changed from the writing mode to the pointing mode or from the pointing mode to the writing mode.

The input apparatus 400 may further include a communication unit (not shown) that transfers a signal informing that the mode change button 430 is selected to the electronic apparatus. The electronic apparatus that receives the signal may change a mode thereof based on the signal and operate in the changed mode.

FIG. 23 illustrates the input apparatus 400 according to some exemplary embodiments.

Referring to FIG. 23, the input apparatus 400 may further include a fixed color button 410 and a color change button 420 in addition to the mode change button 430 described with reference to FIG. 22. The fixed color button 410 and the color change button 420 are elements corresponding to the fixed color button 210 and the color change button 220 of FIG. 15, and thus redundant descriptions will be omitted.

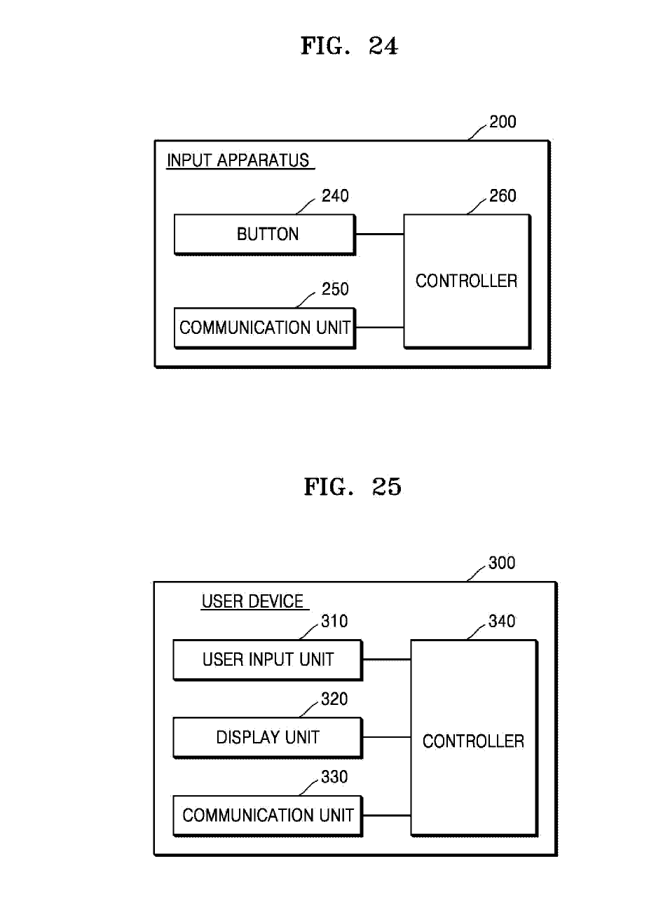

FIG. 24 is a block diagram of a configuration of the input apparatus 200 according to some exemplary embodiments.

Referring to FIG. 24, the input apparatus 200 may include a button 240, a communication unit 250, and a controller 260. The button 240 may include at least one of a fixed color button (210 of FIG. 15), a color change button (220 of FIG. 15), and a mode change button (430 of FIG. 22).

The communication unit 250 may be configured to communicate with an electronic apparatus such as an electronic device (100 of FIG. 17), a user device (300 of FIG. 17), etc. The communication unit 250 may be a unit used to connect to the electronic apparatus by wire or wirelessly. The communication unit 250 may include one or more elements to allow the input apparatus 20 to communicate with the electronic apparatus. For example, the communication unit 250 may include a short-distance communication module, a wired communication module, a mobile communication module, etc.

The communication unit 250 may transfer information informing that the button 240 is selected to the electronic apparatus.

The controller 260 may control a general operation of the input apparatus 200. The controller 260 may control the communication unit 250 to transfer the information informing that the button 240 is selected to the electronic apparatus.

When the button 240 includes the fixed color button (210 of FIG. 15) and the color change button (220 of FIG. 15), the color change button may include a light emitting device configured to emit a plurality of colors, and the fixed color button may also include a light emitting device configured to emit an fixed color.

The controller 260 may control the light emitting device of the fixed color button or the color change button to emit a color that is set in the input apparatus 200.

FIG. 25 is a block diagram of a configuration of the user device 300 according to some exemplary embodiments.

Referring to FIG. 25, the user device 300 may include a user input unit 310, a display unit 320, a communication unit 330, and a controller 340.

The user input unit 310 is used by a user to input data for controlling the user device 300. The user input unit 310 may receive a writing input, various user inputs for controlling the user device 300, etc.

The display unit 320 may be implemented as various display apparatuses.

The communication unit 330 is used to connect an electronic device (100 of FIG. 1) by wire or wirelessly.

The controller 340 may control a general operation of the user device 300. The controller 340 may make the electronic device (100 of FIG. 1) connected to the user device 300 interact with the user device 300. Thus, all descriptions provided with reference to the electronic device above may apply to elements included in the user device 300 corresponding to elements included in the electronic device (100 of FIG. 1).

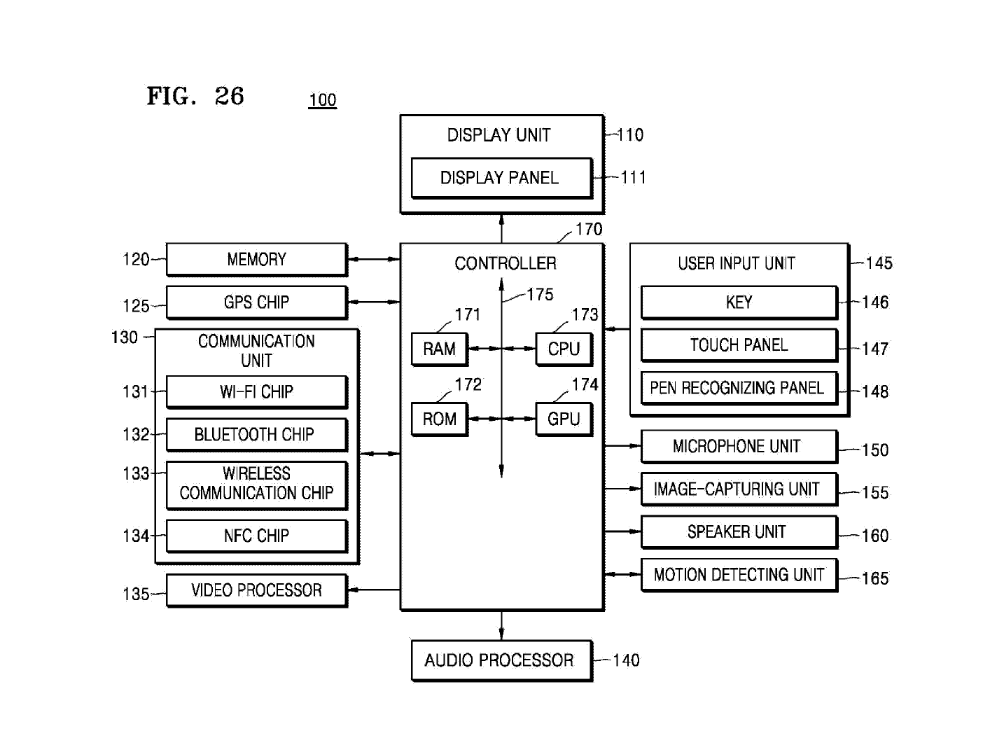

FIG. 26 is a block diagram of a configuration of the electronic device 100 according to some exemplary embodiments. The configuration of the electronic device 100 of FIG. 26 may apply to all the electronic devices described above. The configuration of the electronic device 100 may similarly apply to a user device (300 of FIG. 25) described above.

Referring to FIG. 26, the electronic device 100 may include at least one of a display unit 110, a controller 170, a memory 120, a GPS chip 125, a communication unit 130, a video processor 135, an audio processor 140, a user input unit 145, a microphone unit 150, an image-capturing unit 155, a speaker unit 160, and a motion detecting unit 165.

The display unit 110 may include a display panel 111 and a controller (not shown) that controls the display panel 111. The display panel 111 may be embodied as various displays including a liquid crystal display (LCD), an organic light-emitting diode (OLED) display, an active matrix OLED (AMOLED) display, a plasma display panel (PDP), or the like. The display panel 111 may be formed to be flexible, transparent, and/or wearable. The display panel 111 may be combined with a touch panel 147 of the user input unit 145, and thus may be provided as a touchscreen (not shown). For example, the touchscreen may include an integrated module having a stack structure containing the display panel 111 and the touch panel 147.

The memory 120 may include at least one of an internal memory (not shown) and an external memory (not shown).

The internal memory may include at least one of a volatile memory (e.g., a dynamic random-access memory (DRAM), a static RAM (SRAM), a synchronous dynamic RAM (SDRAM), etc.), a non-volatile memory (e.g., a one-time programmable read-only memory (OTPROM), a programmable ROM (PROM), an erasable and programmable ROM (EPROM), an electrically erasable and programmable ROM (EEPROM), a mask ROM, a flash ROM, etc.), a hard disk drive (HDD), and a solid-state drive (SSD). According to some exemplary embodiments, the controller 170 may load a command or data, which is received from at least one of the non-volatile memory and another element, to the volatile memory, and may process the command or the data. Also, the controller 170 may store, in the non-volatile memory, data that is received from or is generated by another element.

The external memory may include at least one of a compact flash (CF) memory, a secure digital (SD) memory, a micro secure digital (micro-SD) memory, a mini secure digital (mini-SD) memory, an extreme digital (xD) memory, and a memory stick.

The memory 120 may store various programs and data used in operations of the electronic device 100.

The controller 170 may control the display unit 110 to display the portion of the content which is stored in the memory 120. In other words, the controller 1700 may display, on the display unit 110, the portion of the content which is stored in the memory 120. Alternatively, when a user's gesture is performed in a region of the display unit 110, the controller 170 may perform a control operation that corresponds to the user's gesture.

The controller 170 may include at least one of a RAM 170, a ROM 172, a central processing unit (CPU) 173, a graphics processor unit (GPU) 174, and a bus 175. The RAM 171, the ROM 172, the CPU 173, and the GPU 174 may be connected to each other via the bus 175.

The CPU 173 may access the memory 120, and perform a booting operation by using an OS stored in the memory 120. Also, the CPU 173 may perform various operations by using the various programs, a plurality of contents, a plurality of pieces of data, etc. stored in the memory 120.

The ROM 172 may store a command set for booting up a system. For example, when a turn-on command is input to the electronic device 100, and power is supplied to the electronic device 100, the CPU 173 may copy the OS stored in the memory 120 to the RAM 171, according to the command stored in the ROM 172, may execute the OS, and thus may boot up the system. When the booting operation is completed, the CPU 173 copies the various programs stored in the memory 120 to the RAM 171, and performs the various operations by executing the programs copied to the RAM 171. When the electronic device 100 is booted up, the GPU 174 displays a user interface screen in a region of the display unit 110. In more detail, the GPU 174 may generate a screen that displays an electronic document including various objects such as content, an icon, a menu, or the like. The GPU 174 calculates coordinate values of the objects that are to be displayed according to a layout of the user interface screen, and calculates attribute values of shapes, sizes, or colors of the objects. Then, the GPU 174 may generate user interface screens with various layouts including the objects based on the calculated attribute values. The user interface screen generated by the GPU 174 may be provided to the display unit 110 and thus may be displayed in regions of the display unit 110.

The GPS chip 125 may receive a GPS signal from a GPS satellite and may calculate a current position of the electronic device 100. In a case where a navigation program is used or a current position of the user is required, the controller 170 may calculate a position of the user by using the GPS chip 125.

The communication unit 130 may perform communication with various external devices according to various types of communication methods. The communication unit 130 may include at least one of a Wi-Fi chip 131, a Bluetooth chip 132, a wireless communication chip 133, and an NFC chip 134. The controller 170 may perform the communication with the various external devices by using the communication unit 130.

The Wi-Fi chip 131 and the Bluetooth chip 132 may perform communication by using Wi-Fi and Bluetooth, respectively. If the Wi-Fi chip 131 or the Bluetooth chip 132 is used, the Wi-Fi chip 131 or the Bluetooth chip 132 may first transmit and receive various types of connection information including a service set identification (SSID), a session key, or the like, may establish a connection for communication by using the connection information, and then may transmit and receive various types of information. The wireless communication chip 133 may indicate a chip that performs communication according to various communication standards such as the institute of Electrical and Electronics Engineers (IEEE), ZigBee 3^{rd} generation (3G), 3rd Generation Partnership Project (3GPP), Long Term Evolution (LTE), or the like. The NFC chip 1340 may indicate a chip that operates in using NFC by using a 13.56 MHz band from among various radio frequency-identification (RF-ID) frequency bands such as 135 kHz, 13.56 MHz, 433 MHz, 860˜960 MHz, 2.45 GHz, or the like.

The video processor 135 may process video data included in content received by using the communication unit 130 or may process video data included in content stored in the memory 120. The video processor 135 may perform various image processing such as decoding, scaling, noise filtering, frame rate conversion, resolution conversion, or the like on the video data.

The audio processor 140 may process audio data included in content received by using the communication unit 130 or may process audio data included in content stored in the memory 120. The audio processor 140 may perform various processing such as decoding, amplification, noise filtering, or the like on the audio data.

When a reproducing program for multimedia content is executed, the controller 170 may reproduce the multimedia content by driving the video processor 135 and the audio processor 140. The speaker unit 160 may output audio data generated in the audio processor 140.

The user input unit 145 may receive an input of various instructions from a user. The user input unit 145 may include at least one of a key 146, a touch panel 147, and a pen recognizing panel 148.

The key 146 may include various types of keys such as a mechanical button, a wheel, or the like that may be formed in a front portion, a side portion, a rear portion, etc., of an external surface of a body of the electronic device 100.

The touch panel 147 may sense a touch input by the user and may output a value of a touch event that corresponds to a signal generated by the sensed touch input. When the touch panel 147 is combined with the display panel 111 and thus is formed as a touchscreen, the touchscreen may be configured as a capacitive touchscreen, a resistive touchscreen, or a piezoelectric touchscreen by using various types of touch sensors. The capacitive touchscreen may calculate touch coordinates by sensing a small amount of electricity generated when a body part of the user touches the surface of the capacitive touchscreen, which is coated with a dielectric material. The resistive touchscreen may include two embedded electrode plates and may calculate touch coordinates by sensing a flow of current that occurs when the user touches the resistive touchscreen which causes upper and lower plates of a touched point to contact each other. The touch event that occurs on the touchscreen may be generated by a finger of a person but may also be generated by an object formed of a conductive material capable of changing capacitance.

The pen recognizing panel 148 may sense a proximity input or a touch input of a touch pen (e.g., a stylus pen or a digitizer pen) which is performed by a user, and may output a sensed pen proximity event or a sensed pen touch event. The pen recognizing panel 148 may be an electromagnetic resonance (EMR)-type pen recognizing panel, and may sense the touch input or the proximity input according to changes in a strength of an electromagnetic field, which occur when the touch pen approaches or touches the touchscreen. In more detail, the pen recognizing panel 148 may include an electromagnetic induction coil sensor (not shown) having a grid structure, and an electric signal processor (not shown) for sequentially providing an alternating current (AC) signal having a predetermined frequency to each loop coil of the electromagnetic induction coil sensor. When a pen having an internal resonance circuit is positioned near a loop coil of the pen recognizing panel 148, a magnetic field transmitted from the loop coil may generate a current in the resonance circuit in the pen, based on mutual electrostatic induction. Due to the current, an induction field may be generated from a coil forming the resonance circuit in the pen, and the pen recognizing panel 148 may detect the induction field from the loop coil capable of receiving a signal, and thus sense the touch input or the proximity input by the pen. The pen recognizing panel 148 may be arranged to occupy a preset area below the display panel 111, e.g., may have an area capable of covering a display region of the display panel 111.

The microphone unit 150 may receive an input of a user's voice or other sound and may convert the user's voice or other sound to audio data. The controller 170 may use the user's voice, which is input via the microphone unit 150, in a call-related operation or may convert the user's voice to the audio data and may store the audio data in the memory 120.

The image-capturing unit 155 may capture a still image or a moving picture according to control by the user. The image-capturing unit 155 may be plural in number and include a front camera, a rear camera, or the like.

If the image-capturing unit 155 and the microphone unit 150 are present, the controller 170 may perform a control operation according to a user's voice input via the microphone unit 150 or a user's motion recognized by the image-capturing unit 155. For example, the electronic device 100 may operate in a motion control mode or a voice control mode. If the electronic device 100 operates in the motion control mode, the controller 170 may activate the image-capturing unit 155 and may capture an image of the user, may trace a change in motions of the user, and may perform a control operation corresponding thereto. If the electronic device 100 operates in the voice control mode, the controller 170 may analyze a user's voice input via the microphone unit 150, and may operate in a voice recognition mode in which a control operation is performed according to the analyzed user's voice.

The motion detecting unit 165 may detect movement of a body of the electronic device 100. The electronic device 100 may rotate or may tilt in various directions. In this regard, the motion detecting unit 165 may detect a movement characteristic such as a rotation direction, a rotation angle, a tilted angle, or the like by using at least one of a magnetic sensor, a gyroscope sensor, an acceleration sensor, etc.

In addition, although not shown in FIG. 26, the exemplary embodiments may further include a universal serial bus (USB) port for connecting the electronic device 100 and a USB connector, various external input ports including a headset, a mouse, a local area network (LAN), etc. for connection with various external terminals, a digital multimedia broadcasting (DMB) chip for receiving and processing a DMB signal, various sensors, or the like.

Names of elements in the electronic device 100 may vary. Also, the electronic device 100 according to the present exemplary embodiment may include at least one of the aforementioned elements, or may be embodied with more or less elements than the aforementioned elements.

The above-described embodiments of the present invention may be written as computer programs and may be implemented in general-use digital computers that execute the programs using a non-transitory computer-readable recording medium.

Examples of the non-transitory computer-readable recording medium include magnetic storage media (e.g., ROM, floppy disks, hard disks, etc.), optical recording media (e.g., CD-ROMs, or DVDs), etc), and transmission media such as Internet transmission media.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. An electronic device, comprising:
a user input unit configured to receive an input indicative of at least one selection from among a plurality of subjects and a plurality of writing backgrounds and receive a writing input;
a display unit; and
a controller configured to detect writing content that matches the writing input based on the at least one selection from among the plurality of subjects and the plurality of writing backgrounds and output the detected writing content on a screen of the display unit.

2. The electronic device of claim 1, wherein the controller detects the writing content that matches the writing input by determining whether the writing input matches content associated with the at least one selection from among the plurality of subjects and the plurality of writing backgrounds prior to determining whether the writing input matches content other than that is associated with the at least one selection of the plurality of subjects and the plurality of writing backgrounds.

3. The electronic device of claim 2, further comprising:
a memory configured to store a plurality of pieces of writing content according to the plurality of subjects and a plurality of pieces of writing content according to the plurality of writing backgrounds.

4. The electronic device of claim 1, wherein the controller outputs at least one function button associated with the at least one selection from among the plurality of subjects and the plurality of writing backgrounds on the screen.

5. The electronic device of claim 1, further comprising:
a communication unit configured to receive information informing that a fixed color button or a color change button is selected from an input apparatus that includes the fixed color button and the color change button,
wherein the controller outputs color information set in the input apparatus on the screen based on the information.

6. The electronic device of claim 1, further comprising:
a communication unit configured to communicate with a user device,
wherein the controller controls the communication unit so that the screen of the display unit interact with a screen of the user device.

7. The electronic device of claim 6, wherein the writing input is a first writing input, and
the controller receives a second writing input from the user device via the communication unit, detects second writing content that matches the second writing input based on the at least one selection from among the plurality of subjects and the plurality of writing backgrounds, and outputs the second writing content onto the screen.

8. The electronic device of claim 6, wherein the controller outputs a pointer visually associated with a pointer that is input to the user device onto the screen of the display unit.

9. The electronic device of claim 1, further comprising:
a memory configured to store a student list,
wherein the user input unit receives an input instructing selection of a speaker, and
wherein the controller arbitrarily selects a student as the speaker from the student list and outputs a name of the selected student onto the screen.

10. An input apparatus configured to input writing onto a screen of an electronic device, the input apparatus comprising:
a communication unit configured to communicate with the electronic device;
a fixed color button configured to set a color of writing content that is output on the screen of the electronic device as a fixed color;
a color change button configured to change the color of the writing content to one of a plurality of colors; and
a controller configured to control the communication unit to transfer, to the electronic device, information informing that the fixed color button or the color change button is selected.

11. A method of operating an electronic device, the method comprising:
receiving a user input indicative of at least one selection from among a plurality of subjects and a plurality of writing backgrounds;
receiving a writing input;
detecting writing content that matches the writing input based on the at least one selection from among the plurality of subjects and the plurality of writing backgrounds; and
outputting the detected writing content onto a screen.

12. The method of claim 11, wherein the detecting includes determining whether the writing input matches content associated with the at least one selection from among the plurality of subjects and the plurality of writing backgrounds.

13. The method of claim 12, further comprising:
storing a plurality of pieces of writing content according to the plurality of subjects and a plurality of pieces of writing content according to the plurality of writing backgrounds.

14. The method of claim 11, further comprising:
outputting at least one function button associated with the at least one selection from among the plurality of subjects and the plurality of writing backgrounds onto the screen.

15. The method of claim 11, further comprising:
receiving information informing that a fixed color button or a color change button is selected from an input apparatus that includes the fixed color button and the color change button; and
outputting color information set in the input apparatus onto the screen based on the information.

16. The method of claim 11, wherein the screen of the display unit interacts with a screen of the user device.

17. The method of claim 16, wherein the writing input is a first writing input, and the method further comprises:
receiving a second writing input from the user device;
detecting second writing content that matches the second writing input based on the at least one selection from among the plurality of subjects and the plurality of writing backgrounds; and
outputting the second writing content onto the screen.

18. (canceled)

19. The method of claim 11, further comprising:
storing a student list,
receiving an input instructing selection of a speaker;
arbitrarily selecting a student as the speaker from the student list; and
outputting a name of the selected student onto the screen.

20. A non-transitory computer readable recording medium having recorded thereon a computer program, which, when executed by a computer, performs the method of claim 11.

21. A method of an electronic device, comprising:
receiving at least one selection from among subjects and backgrounds for an interface useable to make a user input;
selecting a range of content among a plurality of contents according to the at least one selection; and
detecting the user input by determining whether the user input matches the selected range of content.
